(19) United States
(12) Patent Application Publication
(10) Pub. No.: US 2012/0027978 A1
(43) Pub. Date: Feb. 2, 2012

(54) MULTI-ELEMENT OPTICAL SUBSTRATE AND ITS PREPARATION METHOD, LENS MODULE USING THE MULTI-ELEMENT OPTICAL SUBSTRATE

(76) Inventors: Yu-Sheng Chang, Taichung County (TW); Tsu-Meng Lee, Taichung City (TW); Yu-Chuan Chiu, Taichung County (TW)

(21) Appl. No.: 12/845,418

(22) Filed: Jul. 28, 2010

(51) Int. Cl. G02B 1/04; B32B 3/10; B32B 7/04; B29D 11/00

(52) U.S. Cl. 428/58; 264/1.7; 428/138; 428/76

(57) ABSTRACT

A multi-element optical substrate preparation method includes the steps of: a) preparing a first element having a center hole and a core positioning device defining a first element center line; b) preparing a mold having a mold cavity and a cavity center line, and then placing the first element in the mold to keep a predetermined part of the first element in contact with the mold cavity; c) calibrating the position of the core positioning device of the first element in the mold cavity subject to the reference of the cavity center line of the mold; d) filling a transparent plastic material into the mold cavity of the mold for enabling the transparent plastic material to be molded on the first element and cured into a second element so that the first element and the second element form an optical substrate; and e) opening the mold and taking the optical substrate out of the mold.

### BACKGROUND OF THE INVENTION

1. Field of the Invention

The present invention relates to optical substrate technology and more particularly, to a multi-element optical substrate and its preparation method. The invention relates also to an optical module using the multi-element optical substrate.

2. Description of the Related Art

Normally, an optical substrate has its function block located on the center area, and its border area used for mounting or decoration purpose. Using one single expensive material to make an optical substrate, the manufacturing cost will be high. There, multi-element optical substrates are developed.

However, when molding one element on another element to form a multi-element optical substrate, due to the existence of mold member precision tolerance, the two elements may not have the same optical center. Thus, when one element of a multi-element optical substrate is used for position calibration during installation, the optical center of the second element will not be accurately positioned, lowering the optical performance.

Therefore it is desirable to provide a multi-element optical substrate preparation method that eliminates the aforesaid problem.

### SUMMARY OF THE INVENTION

The present invention has been accomplished under the circumstances in view. It is the main object of the present invention to provide a multi-element optical substrate and its preparation method, which enables a predetermined part of a first element to work as a positioning reference, and then mold a second element on the first element to have the optical center of the second element to be accurately obtained subject to the positioning reference so that an accurate optical center alignment effect can be obtained when the multi-element optical substrate is assembled with other components.

To achieve this and other objects of the present invention, a multi-element optical substrate preparation method includes the steps of: a) preparing a first element having a center hole and a core positioning device defining a first element center line; b) preparing a mold having a mold cavity and a cavity center line, and then placing the first element in the mold to keep a predetermined part of the first element in contact with the mold cavity; c) calibrating the position of the core positioning device of the first element in the mold cavity subject to the reference of the cavity center line of the mold; d) filling a transparent plastic material into the mold cavity of the mold for enabling the transparent plastic material to be molded on the first element and cured into a second element so that the first element and the second element form an optical substrate; and e) opening the mold and taking the optical substrate out of the mold.

The invention also provides a lens module having installed therein a multi-element optical substrate prepared according to the aforesaid preparation method.

To achieve this and other objects of the present invention, a multi-element optical substrate comprises a first element having a center hole and a core positioning device defining a first element center line. And a second element molded on the first element and connected to the center hole of the first element. The second element defines a second element center line that is determined subject to the reference of the core positioning device of the first element.

### BRIEF DESCRIPTION OF THE DRAWINGS

FIG. 1 is a schematic sectional view of a first element for multi-element optical substrate in accordance with a first embodiment of the present invention.

FIG. 2 is a schematic sectional view showing the first element set in a mold in accordance with the first embodiment of the present invention.

FIG. 3 corresponds to FIG. 2, showing a transparent plastic material filled in the mold cavity of the mold.

FIG. 4 is a sectional view of a finished multi-element optical substrate in accordance with the first embodiment of the present invention.

FIG. 5 is a schematic sectional view of a first element for multi-element optical substrate in accordance with a second embodiment of the present invention.

FIG. 6 is a schematic sectional view showing the first element set in a mold in accordance with the second embodiment of the present invention.

FIG. 7 corresponds to FIG. 6, showing a transparent plastic material filled in the mold cavity of the mold.

FIG. 8 is a sectional view of a finished multi-element optical substrate in accordance with the second embodiment of the present invention.

FIG. 9 is a schematic sectional view of a first element for multi-element optical substrate in accordance with a third embodiment of the present invention.

FIG. 10 is a schematic sectional view showing the first element set in a mold in accordance with the third embodiment of the present invention.

FIG. 11 corresponds to FIG. 1-, showing a transparent plastic material filled in the mold cavity of the mold.

FIG. 12 is a sectional view of a finished multi-element optical substrate in accordance with the third embodiment of the present invention.

FIG. 13 is a sectional assembly view of a lens module made according to the present invention.

### DETAILED DESCRIPTION OF THE INVENTION

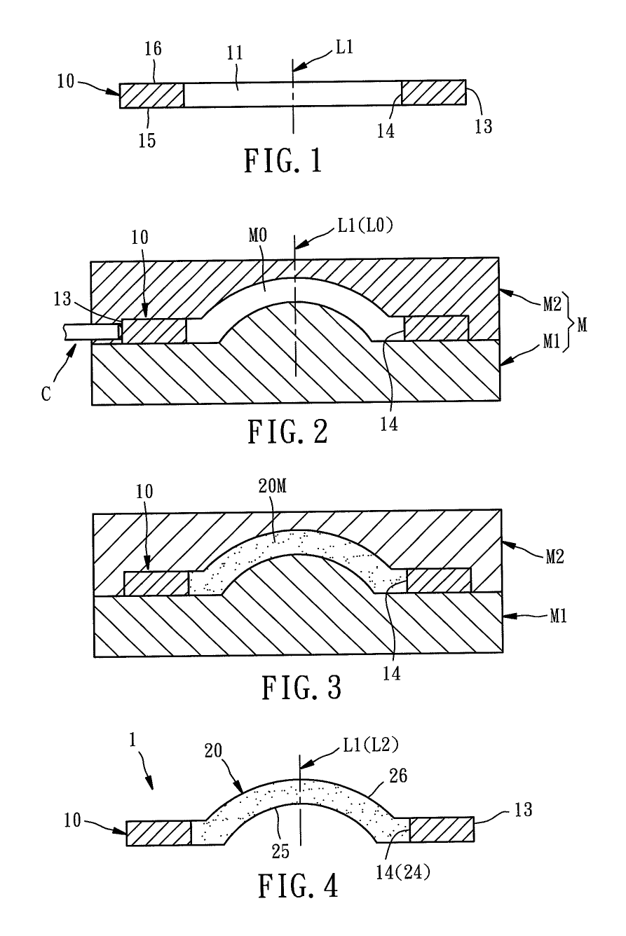

The advantages and features of the present invention will be understood by reference to the following specification in conjunction with the accompanying drawings, in which like reference signs denote like elements of structure, in which, please refer to FIGS. 1˜4, a multi-element optical substrate preparation method in accordance with a first embodiment of the present invention includes the steps of:

a) preparing a first element 10 that has a bottom wall 15, a top wall 16, a center hole 11 cut through the top and bottom walls 15;16, an outer race 13 that forms a core positioning device defining a first element center line L1, and an inner race 14;

b) preparing a mold M having a mold cavity M0 and a cavity center line L0, and then placing the first element 10 in the mold M to keep a predetermined part of the first element 10 in contact with the mold cavity M0;

c) calibrating the position of the core positioning device of the first element 10 in the mold cavity M0 subject to the reference of the cavity center line L0 of the mold M by using a core positioning tool C;

d) filling a transparent plastic material 20M into the mold cavity M0 of the mold M for enabling the transparent plastic material 20M to be molded on the first element 10 and cured into a second element 20 so that the first element 10 and the second element 20 form an optical substrate 1, wherein filling of the transparent plastic material 20M can be achieved by spot-gluing, injection or extrusion; wherein the second element 20 and the first element 10 are joined together in a butt joint manner; wherein the transparent plastic material 20M is a light-curing or cold-curing material; and

e) opening the mold M and taking the optical substrate 1 out of the mold M.

According to this first embodiment, the center line L1 of the first element 10 is coincided with the cavity center line L0 of the mold M.

Based on the aforesaid steps, the invention provides an optical substrate 1, comprising a first element 10 and a second element 20. The second element 20 comprises a first element connection portion 24, a bottom wall 25 and a top wall 26. The bottom wall 25 and the top wall 26 define a second element's center line L2 that is coincided with the center line L1 of the first element 10.

Thus, when the outer race 13 of the first element 10 is fastened to another component (for example, lens module), the second element's center line L2 of the second element 20 is accurately kept in axial alignment with the axis to be set, assuring an accurate optical projection effect.

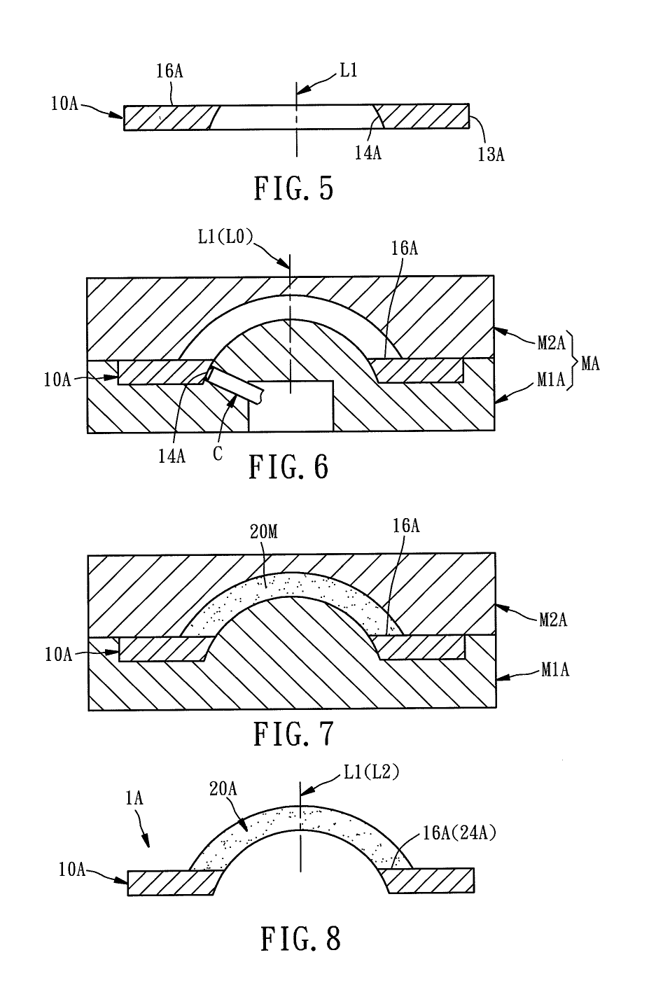

Referring to FIGS. 5˜8, a multi-element optical substrate preparation method in accordance with a second embodiment of the present invention is substantially similar to the aforesaid first embodiment. A multi-element optical substrate 1A prepared in accordance this second embodiment, comprises a first element 10A and a second element 20A. The second element 20A and the first element 10A are joined together in a lap joint manner, i.e., the first element connection portion 24A of the second element 20A is bonded to a top wall 16A of the first element 10A.

Further, when calibrating the position of the first element center line L1 based on the cavity center line L0 of the mold MA, the core positioning tool C is positioned on the inner race 14A of the first element 10A. It is to be understood that the core positioning device can be positioned on the outer race 13A (not shown) as the aforesaid first step, or positioned on both the outer race and the inner race.

Further, the mold cavity of the mold MB is located on the second mold member M2B, facilitating positioning and/or molding.

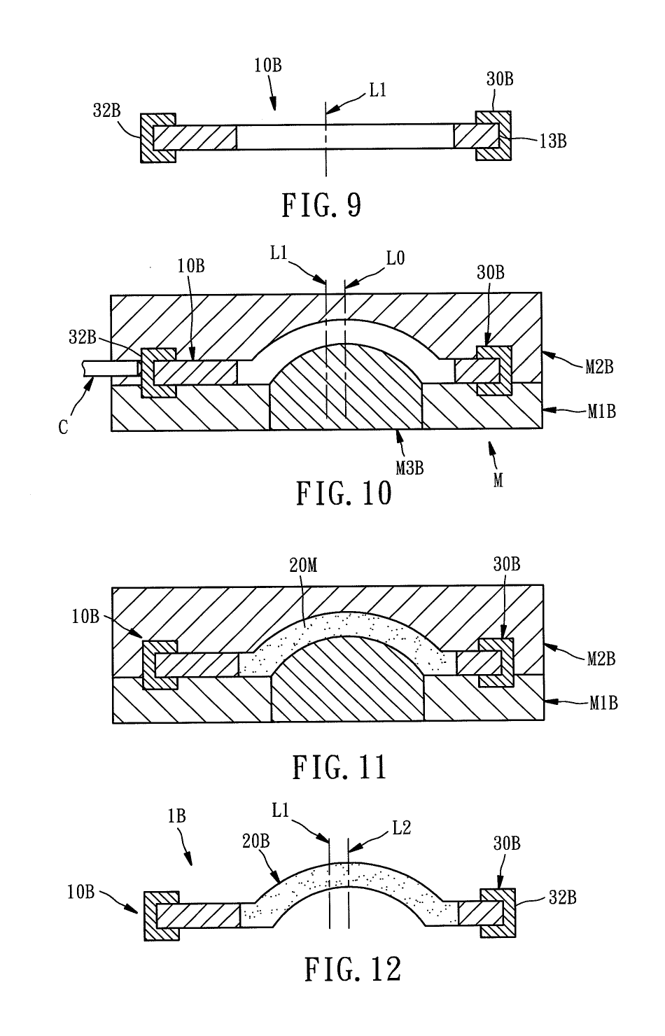

Referring to FIGS. 9˜12, a multi-element optical substrate preparation method in accordance with a third embodiment of the present invention is substantially similar to the aforesaid first and second embodiments. A multi-element optical substrate 1B prepared in accordance this third embodiment, comprises a first element 10B and a second element 20B, wherein the first element 10B has a peripheral cover member 30B packed on the outer race 13B.

According to this third embodiment, the periphery 32B of the peripheral cover member 30B of the first element 10B works as the core positioning device to have the center axis of the first element 10B be positioned on the device at the peripheral cover member 30B.

Further, the cavity center line L0 for calibrating the position of the second element's center line L2 is disposed in parallel to the first element center line L1, thus, another multi-element optical substrate is obtained where the second element's center line L2 can be accurately positioned relative to the first element center line L1.

Further, the mold MB in accordance with this third embodiment has an added more core M3B.

In conclusion, based on the aforesaid preparation methods, a multi-element optical substrate comprises:

a first element 10;10A;10B, having a center hole 11 and a core positioning device that defines a first element center line L1; and

a second element 20;20A;20B connected to the center hole 11 of the first element 10;10A;10B and cured and bonded to the first element 10;10A;10B;

wherein the second element's center line L2 is determined subject to the reference of the core positioning device of the first element 10;10A;10B.

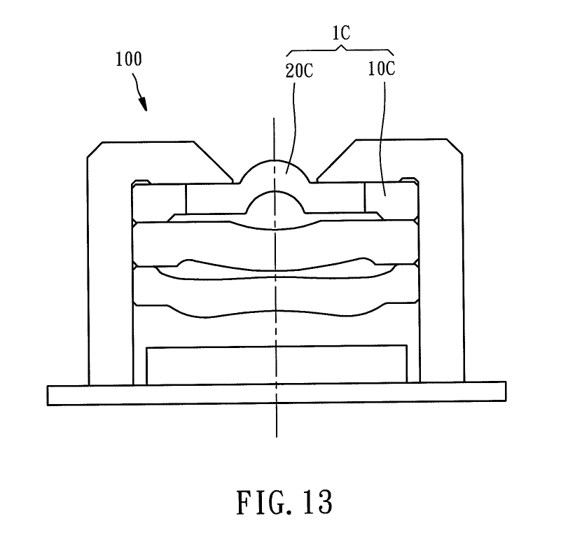

Further, the invention provides a lens module 100 having installed therein a multi-element optical substrate 1C, wherein the first element 10C of the multi-element optical substrate 1C is mounted in the lens barrel of the lens module in front of other lens elements of the lens module; the second element 20C is in axial alignment with an aperture of the lens barrel, as shown in FIG. 13.

The above described embodiments are simple examples of the present invention. The preparation steps, materials used and structures of elements may be alternatively changed. Further, each of the aforesaid embodiments may be modified subject to the following modifications and their combinations.

At first, except having an outer race and an inner race, the first element has its inner race to work as the core positioning device.

Thereafter, the filling of the plastic material can be achieved by means of spot-gluing, injection or extrusion.

Further, except that the second element must be prepared from a light transmission material, the first element can be prepared from a light transmission material, a translucent material or an opaque material. Thus, invention facilitates material selection, saving the cost. When a translucent or opaque material is used for the first element, the material provides a light shielding effect. Further, the first element and the second element can be prepared from glass, or temperature-resistant resin that resists temperature 300˜500° C. and can be made by means of injection molding.

Further, the second element can be a convex lens or concave lens.

Further, the cavity center line of the mold and the center line of the first element can be coincided with each other, arranged in a parallel manner, or tiled relative to each other to define a contained angle.

Further, the center line of the second element and the center line of the first element can be coincided with each other, arranged in a parallel manner, or tiled relative to each other to define a contained angle.

In general, the present invention having been thus described with particular reference to the preferred embodiments thereof, it will be understood that in a multi-element optical substrate and its preparation method according to the present invention, a predetermined part of a first element works as a positioning reference, a second element is formed and bonded to the first element to have the optical center of the second element be accurately obtained subject to the positioning reference of the first element. Thus, after installation of the multi-element optical substrate in another component, an accurate optical center alignment effect is obtained.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A multi-element optical substrate preparation method, comprising the steps of:
a) preparing a first element having a center hole and a core positioning device defining a first element center line;
b) preparing a mold having a mold cavity and a cavity center line, and then placing said first element in said mold to keep a predetermined part of said first element in contact with said mold cavity;
c) calibrating the position of said core positioning device of said first element in said mold cavity subject to the reference of said cavity center line of said mold;
d) filling a transparent plastic material into said mold cavity of said mold for enabling said transparent plastic material to be molded on said first element and cured into a second element so that said first element and said second element form an optical substrate; and
e) opening said mold and taking said optical substrate out of said mold.

2. The multi-element optical substrate preparation method as claimed in claim 1, wherein said first element comprises an outer race and an inner race, one of said outer race and said inner race forming said core positioning device.

3. The multi-element optical substrate preparation method as claimed in claim 1, wherein said first element is set in said mold cavity of said mold in one of a position where said cavity center line of said mold is coincided with said first element center line of said first element, a second position where said cavity center line of said mold is kept in parallel to said first element center line of said first element and a third position where said cavity center line of said mold and said first element center line of said first element define a contained angle.

4. The multi-element optical substrate preparation method as claimed in claim 2, wherein said second element and said first element are joined together by means of a butt joint or a lap joint.

5. The multi-element optical substrate preparation method as claimed in claim 1, wherein said transparent plastic material is filled in said mold cavity of said mold by spot-gluing technique, injection technique or extrusion technique.

6. The multi-element optical substrate preparation method as claimed in claim 2, wherein said first element further comprises a peripheral cover member packed on said outer race.

7. The multi-element optical substrate preparation method as claimed in claim 6, wherein the core positioning device of said first element is located on said peripheral cover member.

8. A multi-element optical substrate, comprising:
a first element, said first element having a center hole and a core positioning device defining a first element center line; and
a second element molded on said first element and connected to said center hole of said first element, said second element defining a second element center line, said second element center line of said second element being determined subject to the reference of said core positioning device of said first element.

9. The multi-element optical substrate as claimed in claim 8, wherein said first element comprises an outer race and an inner race; said core positioning device is formed of one of said outer race and said inner race.

10. The multi-element optical substrate as claimed in claim 8, wherein said second element is bonded to said first element in one of a first element where said first element center line of said first element and said second element center line of said second element are coincided with each other, a second position where said first element center line of said first element and said second element center line of said second element are kept in parallel, and a third position where said first element center line of said first element and said second element center line of said second element define a contained angle.

11. The multi-element optical substrate as claimed in claim 8, wherein said second element and said first element are joined together by means of a butt joint or lap joint.

12. The multi-element optical substrate as claimed in claim 8, wherein said second element is prepared from a plastic material by means of one of spot gluing, injection and extrusion techniques.

13. The multi-element optical substrate as claimed in claim 8, wherein said first element further comprises a peripheral cover member packed on said outer race.

14. The multi-element optical substrate as claimed in claim 13, wherein the core positioning device of said first element is located on said peripheral cover member.

15. A lens module having mounted therein a multi-element optical substrate prepared subject to claim 8.

16. A lens module having mounted therein a multi-element optical substrate prepared subject to claim 1.
